(19) United States
(12) Patent Application Publication
(10) Pub. No.: US 2026/0039897 A1
(43) Pub. Date: Feb. 5, 2026

(54) IMAGE DISPLAY DEVICE AND METHOD FOR CONTROLLING THE SAME

(71) Applicant: LG ELECTRONICS INC., Seoul (KR)

(72) Inventor: Byeongkook KANG, Seoul (KR)

(73) Assignee: LG ELECTRONICS INC., Seoul (KR)

(21) Appl. No.: 19/062,537

(22) Filed: Feb. 25, 2025

(30) Foreign Application Priority Data
Jul. 31, 2024 (KR) 10-2024-0102112

(51) Int. Cl. H04N 21/43

(52) U.S. Cl. CPC H04N 21/4307; H04N 21/4305

(57) ABSTRACT

An image display device and a method for controlling the same are disclosed. The image display device is configured so that images are reproduced and displayed without being broken even if a frame rate of an input video signal changes. The image display device includes a display; a communication unit configured to communicate with a video player; and a controller. The controller receives auxiliary video information (AVI) frequency information of a video signal received from the video player, presets a frame rate of the video signal based on the received AVI frequency information when the AVI frequency information is not a preset default value, and controls the video signal to be displayed on the display according to the preset frame rate.

### CROSS-REFERENCE TO RELATED APPLICATIONS

Pursuant to 35 U.S.C. § 119, this application claims the benefit of earlier filing date and right of priority to Korean Patent Application No. 10-2024-0102112 filed on Jul. 31, 2024, the contents of which are all hereby incorporated by reference herein in their entireties.

### BACKGROUND OF THE DISCLOSURE

### Field of the Disclosure

The present disclosure is applicable to an image display device capable of reproducing (playing back) images of various video formats, and a method for controlling the same.

### Discussion of the Related Art

An image display device includes, for example, a function for receiving and processing a broadcast image viewable by a user. The image display device displays a broadcast, which is selected by the user from among broadcast signals transmitted from a broadcast station, on a display. Currently broadcasters are transitioning from analog to digital broadcasting.

Digital broadcasting refers to broadcasting of digital video and audio signals. The digital broadcast has low data loss due to robustness against external noise, error correction, high resolution and a high-definition screen, as compared with an analog broadcast. In addition, digital broadcasting can provide a bidirectional service unlike analog broadcasting.

In order to use digital broadcasting including a variety of content, the performance of an image display device has been improved and the function thereof has been diversified. As the performance of the image display device has been improved, various functions of the image display device, such as gaming, music listening or Internet shopping, using various applications can be performed in addition to a function for receiving a video signal from a broadcast station and viewing a broadcast.

Video signals may have different video formats depending on types thereof. For example, a frame rate of a video signal output by a player may vary depending on settings of the player (e.g., a laptop, a personal computer (PC), a smartphone, a tablet, a set-top box (STB), etc.) that reproduces (plays back) the video signal.

Therefore, an image display device that receives and displays video signals output from a player needs to be implemented so that the image can be reproduced (played back) and displayed without image damage even if the frame rate of the video signal changes.

### SUMMARY OF THE DISCLOSURE

An object of the present disclosure is to provide an image display device capable of reproducing and displaying images without image damage even if the frame rate of the input video signal changes, and a method for controlling the same.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, an image display device may include: a display; a communication unit configured to communicate with a video player; and a controller. The controller may receive auxiliary video information (AVI) frequency information of a video signal received from the video player, may preset a frame rate of the video signal based on the received AVI frequency information when the AVI frequency information is not a preset default value, and may control the video signal to be displayed on the display according to the preset frame rate.

The controller may calculate a frame rate based on the video signal when the AVI frequency information is a preset default value; and may control the video signal to be displayed on the display according to the preset frame rate.

The controller may calculate the frame rate based on a horizontal resolution, a vertical resolution, and a pixel clock of the video signal.

The image display device may further include: a storage unit. The controller is configured to, when the AVI frequency information of the video signal is not received, preset the frame rate of the video signal based on vendor specific infoframe (VSIF) frequency information stored in a VSIF buffer present in the storage unit; and control the video signal to be displayed on the display according to the preset frame rate.

The controller is configured to: when the VSIF frequency information is not present in the VSIF buffer, calculate the frame rate based on the video signal; and control the video signal to be displayed on the display according to the preset frame rate.

The controller is configured to: when the frame rate of the video signal is less than or equal to a first frequency, receive original AVI frequency information of the video signal from the video player as the AVI frequency information; and when the frame rate of the video signal is less than the first frequency, receive the preset default value from the video player as the AVI frequency information.

The first frequency may be set to 120 Hz.

The controller is configured to: when the frame rate of the video signal is less than or equal to a second frequency, receive the VSIF frequency information of the video signal from the video player, and store the received VSIF frequency information in the VSIF buffer.

The second frequency may be set to 30 Hz.

The video signal may be a high definition multimedia interface (HDMI)-type video signal.

In accordance with another aspect of the present disclosure, a method for controlling an image display device may include: communicating with a video player; receiving auxiliary video information (AVI) frequency information of a video signal received from the video player; receiving auxiliary video information (AVI) frequency information of a video signal received from the video player; presetting a frame rate of the video signal based on the received AVI frequency information when the AVI frequency information is not a preset default value; and controlling the video signal to be displayed on a display according to the preset frame rate.

Effects of the image display device and the control method thereof according to the present disclosure will be described below.

According to at least one of various aspects according to the present disclosure, there is an advantage in that the images can be reproduced and displayed without being broken even if the frame rate of the input video signal changes.

Effects obtainable from the present disclosure may be non-limited by the above-mentioned effects. And, other unmentioned effects can be clearly understood from the following description by those having ordinary skill in the technical field to which the present disclosure pertains.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a schematic block diagram of an image display device according to one aspect of the present disclosure.

FIG. 2 is a diagram illustrating an example in which an image display device is connected to a video player according to one aspect of the present disclosure.

FIG. 3 is a table regarding transmission of AVI information and VSIF information of a video signal according to one aspect of the present disclosure.

FIG. 4 is a flowchart illustrating a method for enabling the image display device to display video signals according to one aspect of the present disclosure.

FIG. 5 is a diagram illustrating an example of a screen image displayed by the image display device designed to use the method of FIG. 4 according to the present disclosure.

FIG. 6 is a table regarding transmission of AVI information and VSIF information of video signals according to one aspect of the present disclosure.

FIG. 7 is a flowchart illustrating a method for enabling the image display device to display video signals according to one aspect of the present disclosure.

FIG. 8 is a diagram illustrating an example of a screen image displayed by the image display device designed to use the method of FIG. 7 according to the present disclosure.

### DETAILED DESCRIPTION OF THE DISCLOSURE

Description will now be given in detail according to exemplary aspects disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well known to one of ordinary skill in the relevant art has generally been omitted for the sake of brevity. The accompanying drawings are used to help easily understand various technical features and it should be understood that the aspects presented herein are not limited by the accompanying drawings. As such, the present disclosure should be construed to extend to any alterations, equivalents and substitutes in addition to those which are particularly set out in the accompanying drawings.

The terms “module” and “unit” attached to describe the names of components are used herein to help the understanding of the components and thus should not be considered as having specific meanings or roles. Accordingly, the terms “module” and “unit” may be used interchangeably.

In addition, each of these components may be configured as a separate individual hardware module or implemented as two or more hardware modules. Two or more components may be implemented as a single hardware module, or in some cases, may be implemented as software.

Aspects of this disclosure will be described in detail with reference to the attached drawings, but it should be understood that they are merely illustrative of this disclosure and should not be interpreted as limiting the scope of this disclosure.

In addition, although the terms used in this disclosure are selected from generally known and used terms, some of the terms mentioned in the description of this disclosure, the detailed meanings of which are described in relevant parts of the description herein, have been selected at the discretion of the applicant. Furthermore, this disclosure must be understood, not simply by the actual terms used but by the meanings of each term lying within.

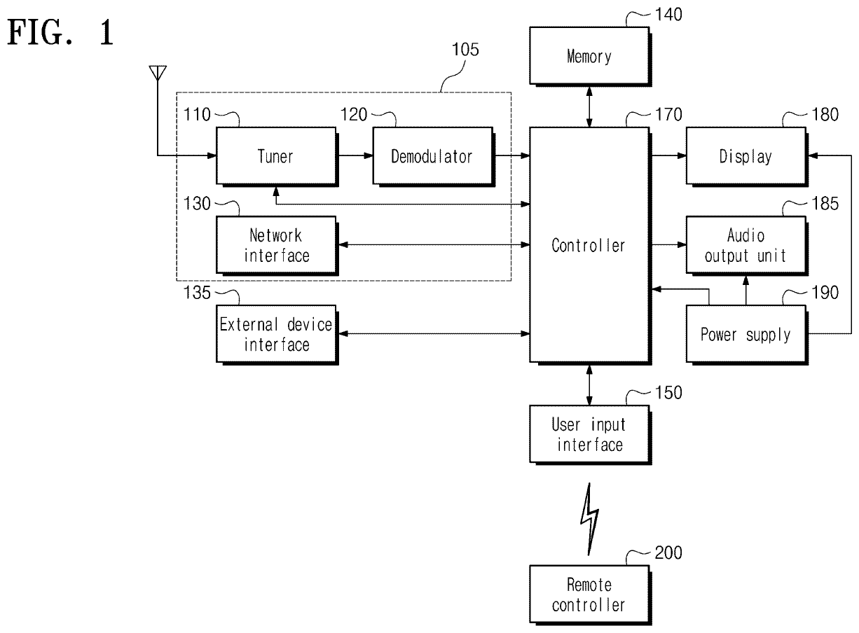

FIG. 1 is a schematic block diagram of an image display device according to one aspect of the present disclosure.

Referring to FIG. 1, an image display device 100 according to one aspect of this disclosure includes a broadcast receiver 105, an external device interface 135, a memory 140, a user input interface 150, a controller 170, a display 180, an audio output unit 185, a power supply 190, and a camera module (not shown).

The broadcasting receiver 105 may include a tuner 110, a demodulator 120 and a network interface 130. As needed, the broadcasting receiver 105 may be configured so as to include only the tuner 110 and the demodulator 120 or only the network interface 130.

The tuner 110 tunes to a Radio Frequency (RF) broadcast signal corresponding to a channel selected by a user from among a plurality of RF broadcast signals received through an antenna and downconverts the tuned RF broadcast signal into a digital Intermediate Frequency (IF) signal or an analog baseband video or audio signal.

More specifically, if the tuned RF broadcast signal is a digital broadcast signal, the tuner 110 downconverts the tuned RF broadcast signal into a digital IF signal DIF. On the other hand, if the tuned RF broadcast signal is an analog broadcast signal, the tuner 110 downconverts the tuned RF broadcast signal into an analog baseband video or audio signal CVBS/SIF. That is, the tuner 110 may be a hybrid tuner capable of processing not only digital broadcast signals but also analog broadcast signals. The analog baseband video or audio signal CVBS/SIF may be directly input to the controller 170.

The tuner 110 may be capable of receiving RF broadcast signals from an Advanced Television Systems Committee (ATSC) single-carrier system or from a Digital Video Broadcasting (DVB) multi-carrier system.

The tuner 110 may sequentially tune to a number of RF broadcast signals corresponding to all broadcast channels previously stored by a channel storage function from a plurality of RF signals received through the antenna and may downconvert the tuned RF broadcast signals into IF signals or baseband video or audio signals.

The demodulator 120 receives the digital IF signal DIF from the tuner 110 and demodulates the digital IF signal DIF.

For example, if the digital IF signal DIF is an ATSC signal, the demodulator 120 may perform 8-Vestigal SideBand (VSB) demodulation on the digital IF signal DIF. The demodulator 120 may also perform channel decoding. For channel decoding, the demodulator 120 may include a Trellis decoder (not shown), a de-interleaver (not shown) and a Reed-Solomon decoder (not shown) so as to perform Trellis decoding, de-interleaving and Reed-Solomon decoding.

For example, if the digital IF signal DIF is a DVB signal, the demodulator 120 performs Coded Orthogonal Frequency Division Multiple Access (COFDMA) demodulation upon the digital IF signal DIF. The demodulator 120 may also perform channel decoding. For channel decoding, the demodulator 120 may include a convolution decoder (not shown), a de-interleaver (not shown), and a Reed-Solomon decoder (not shown) so as to perform convolution decoding, de-interleaving, and Reed-Solomon decoding.

The demodulator 120 may perform demodulation and channel decoding on the digital IF signal DIF, thereby obtaining a Transport Stream (TS). The TS may be a signal in which a video signal, an audio signal and a data signal are multiplexed. For example, the TS may be an MPEG-2 TS in which an MPEG-2 video signal and a Dolby AC-3 audio signal are multiplexed. An MPEG-2 TS may include a 4-byte header and a 184-byte payload.

In order to properly handle not only ATSC signals but also DVB signals, the demodulator 120 may include an ATSC demodulator and a DVB demodulator.

The TS output from the demodulator 120 may be input to the controller 170 and thus subjected to demultiplexing and A/V signal processing. The processed video and audio signals are output to the display 180 and the audio output unit 185, respectively.

The external device interface 135 may serve as an interface between an external device and the image display device 100. For interfacing, the external device interface 135 may include an A/V Input/Output (I/O) unit (not shown) and/or a wireless communication module (not shown).

The external device interface 135 may be connected to an external device such as a Digital Versatile Disc (DVD) player, a Blu-ray player, a game console, a camera, a camcorder, or a computer (e.g., a laptop computer), wirelessly or by wire. Then, the external device interface 135 externally receives video, audio, and/or data signals from the external device and transmits the received input signals to the controller 170. In addition, the external device interface 135 may output video, audio, and data signals processed by the controller 170 to the external device. In order to receive or transmit audio, video and data signals from or to the external device, the external device interface 135 includes the A/V I/O unit (not shown) and/or the wireless communication module (not shown).

The A/V I/O unit may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-sub port, in order to input the video and audio signals of the external device to the image display device 100.

The wireless communication module may perform short-range wireless communication with other electronic devices. For short-range wireless communication, the wireless communication module may use Bluetooth, Radio-Frequency IDentification (RFID), Infrared Data Association (IrDA), Ultra WideBand (UWB), ZigBee, and Digital Living Network Alliance (DLNA) communication standards.

The external device interface 135 may be connected to various set-top boxes through at least one of the above-described ports and may thus perform an I/O operation with the various set-top boxes.

The external device interface 135 may receive applications or an application list from an adjacent external device and provide the applications or the application list to the controller 170 or the memory 140.

The network interface 130 serves as an interface between the image display device 100 and a wired/wireless network such as the Internet. The network interface 130 may include an Ethernet port for connection to a wired network. For connection to wireless networks, the network interface 130 may use Wireless Local Area Network (WLAN) (i.e., Wi-Fi), Wireless Broadband (WiBro), World Interoperability for Microwave Access (WiMax), and High Speed Downlink Packet Access (HSDPA).

The network interface 130 may transmit data to or receive data from another user or electronic device over a connected network or another network linked to the connected network. Especially, the network interface 130 may transmit data stored in the image display device 100 to a user or electronic device selected from among users or electronic devices pre-registered with the image display device 100.

The network interface 130 may access a specific Web page over a connected network or another network linked to the connected network. That is, the network interface 130 may access a specific Web page over a network and transmit or receive data to or from a server. Additionally, the network interface 130 may receive content or data from a CP or an NP. Specifically, the network interface 130 may receive content such as movies, advertisements, games, VoD, and broadcast signals, and information related to the content from a CP or an NP. Also, the network interface 130 may receive update information about firmware from the NP and update the firmware. The network interface 130 may transmit data over the Internet or to the CP or the NP.

The network interface 130 may selectively receive a desired application among open applications over a network.

In an aspect of this disclosure, when a game application is executed in the image display device, the network interface 130 may transmit data to or receive data from a user terminal connected to the image display device through a network. In addition, the network interface 130 may transmit specific data to or receive specific data from a server that records game scores.

The memory 140 may store various programs necessary for the controller 170 to process and control signals, and may also store processed video, audio and data signals.

The memory 140 may temporarily store a video, audio and/or data signal received from the external device interface 135 or the network interface 130. The memory 140 may store information about broadcast channels by the channel storage function.

The memory 140 may store applications or a list of applications received from the external device interface 135 or the network interface 130.

In an aspect of this disclosure, when the image display device provides a game application, the memory 140 may store user-specific information and game play information of a user terminal used as a game controller.

The memory 140 may include, for example, at least one of a flash memory-type storage medium, a hard disk-type storage medium, a multimedia card micro-type storage medium, a card-type memory (e.g. a Secure Digital (SD) or extreme Digital (XD) memory), a Random Access Memory (RAM), or a Read-Only Memory (ROM) such as an Electrically Erasable and Programmable Read Only Memory (EEPROM). The image display device 100 may reproduce content stored in the memory 140 (e.g. video files, still image files, music files, text files, and application files) to the user.

While the memory 140 is shown in FIG. 1 as configured separately from the controller 170, to which this disclosure is not limited, the memory 140 may be incorporated into the controller 170, for example.

The user input interface 150 transmits a signal received from the user to the controller 170 or transmits a signal received from the controller 170 to the user.

For example, the user input interface 150 may receive control signals such as a power-on/off signal, a channel selection signal, and a screen setting signal from a remote controller 200 or may transmit a control signal received from the controller 170 to the remote controller 200, according to various communication schemes, for example, RF communication and IR communication.

For example, the user input interface 150 may provide the controller 170 with control signals received from local keys (not shown), such as inputs of a power key, a channel key, and a volume key, and setting values.

Also, the user input interface 150 may transmit a control signal received from a sensor unit (not shown) for sensing a user gesture to the controller 170 or transmit a signal received from the controller 170 to the sensor unit. The sensor unit may include a touch sensor, a voice sensor, a position sensor, a motion sensor, etc.

The controller 170 may demultiplex the TS received from the tuner 110, the demodulator 120, or the external device interface 135 into a number of signals and process the demultiplexed signals into audio and video data.

The video signal processed by the controller 170 may be displayed as an image on the display 180. The video signal processed by the controller 170 may also be transmitted to an external output device through the external device interface 135.

The audio signal processed by the controller 170 may be audibly output through the audio output unit 185. Also, the audio signal processed by the controller 170 may be transmitted to the external output device through the external device interface 135.

While not shown in FIG. 1, the controller 170 may include a DEMUX and a video processor, which will be described later with reference to FIG. 10.

In addition, the controller 170 may provide overall control to the image display device 100. For example, the controller 170 may control the tuner 110 to tune to an RF broadcast signal corresponding to a user-selected channel or a pre-stored channel.

The controller 170 may control the image display device 100 according to a user command received through the user input interface 150 or according to an internal program. Especially the controller 170 may access a network and download an application or application list selected by the user to the image display device 100 over the network.

For example, the controller 170 controls the tuner 110 to receive a signal of a channel selected according to a specific channel selection command received through the user input interface 150 and processes a video, audio and/or data signal of the selected channel. The controller 170 outputs the processed video or audio signal along with information about the user-selected channel to the display 180 or the audio output unit 185.

As another example, the controller 170 outputs a video or audio signal received from an external device such as a camera or a camcorder through the external device interface 135 to the display 180 or the audio output unit 185 according to an external device video playback command received through the external device interface 150.

The controller 170 may control the display 180 to display images. For instance, the controller 170 may control the display 180 to display a broadcast image received from the tuner 110, an externally input image received through the external device interface 135, an image received through the network interface 130, or an image stored in the memory 140. The image displayed on the display 180 may be a Two-Dimensional (2D) or Three-Dimensional (3D) still image or moving picture.

The controller 170 may control content playback. The content may include any content stored in the image display device 100, received broadcast content, and externally input content. The content includes at least one of a broadcast image, an externally input image, an audio file, a still image, a Web page, or a text file.

Upon receipt of a return-to-home screen input, the controller 170 may control display of the home screen on the display 180.

The home screen may include a plurality of card objects classified according to content sources. The card objects may include at least one of a card object representing a thumbnail list of broadcast channels, a card object representing a broadcast program guide, a card object representing a program reservation list or a program recording list, or a card object representing a media list of a device connected to the image display device. The card objects may further include at least one of a card object representing a list of connected external devices or a card object representing a call-associated list.

The home screen may further include an application menu including at least one application that can be executed.

Upon receipt of a card object move input, the controller 170 may control movement of a card object corresponding to the card object move input on the display 180, or if the card object is not displayed on the display 180, the controller 170 may control display of the card object on the display 180.

When a card object is selected from among the card objects on the home screen, the controller 170 may control display of an image corresponding to the selected card object on the display 180.

The controller 170 may control display of an input broadcast image and an object representing information about the broadcast image in a card object representing broadcast images. The size of the broadcast image may be set to a fixed size.

The controller 170 may control display of a set-up object for at least one of image setting, audio setting, screen setting, reservation setting, setting of a pointer of the remote controller, or network setting on the home screen.

The controller 170 may control display of a log-in object, a help object, or an exit object on a part of the home screen.

The controller 170 may control display of an object representing the total number of available card objects or the number of card objects displayed on the display 180 among all card objects, on a part of the home screen.

If one of the card objects displayed on the display 180 is selected, the controller 170 may fullscreen the selected card object to cover the entirety of the display 180.

Upon receipt of an incoming call at a connected external device or the image display device 100, the controller 170 may control focusing-on or shift of a call-related card object among the plurality of card objects.

If an application view menu item is selected, the controller 170 may control display of applications or a list of applications that are present in the image display device 100 or downloadable from an external network.

The controller 170 may control installation and execution of an application downloaded from the external network along with various UIs. Also, the controller 170 may control display of an image related to the executed application on the display 180, upon user selection.

Although not shown, the image display device 100 may further include a channel browsing processor for generating thumbnail images corresponding to channel signals or externally input signals.

The channel browsing processor may receive the TS output from the demodulator 120 or the TS output from the external device interface 135, extract images of the received TS and generate thumbnail images. The thumbnail images may be directly output to the controller 170 or may be output after being encoded. Also, it is possible to encode the thumbnail images into a stream and output the stream to the controller 170. The controller 170 may display a thumbnail list including a plurality of received thumbnail images on the display 180. The thumbnail images may be updated sequentially or simultaneously in the thumbnail list. Therefore, the user can readily identify the content of broadcast programs received through a plurality of channels.

The display 180 may convert a processed video signal, a processed data signal, and an OSD signal received from the controller 170 or a video signal and a data signal received from the external device interface 135 into RGB signals, thereby generating driving signals.

The display 180 may be various types of displays such as a Plasma Display Panel (PDP), a Liquid Crystal Display (LCD), an Organic Light-Emitting Diode (OLED) display, a flexible display, and a 3D display.

The display 180 may also be a touchscreen that can be used not only as an output device but also as an input device.

The audio output unit 185 may receive a processed audio signal (e.g., a stereo signal, a 3.1-channel signal or a 5.1-channel signal) from the controller 170 and output the received audio signal as sound. The audio output unit 185 may employ various speaker configurations.

To sense a user gesture, the image display device 100 may further include the sensor unit (not shown) that has at least one of a touch sensor, a voice sensor, a position sensor, and a motion sensor, as stated before. A signal sensed by the sensor unit may be output to the controller 170 through the user input interface 150.

The image display device 100 may further include the camera unit (not shown) for capturing images of a user. Image information captured by the camera unit may be input to the controller 170.

The controller 170 may sense a user gesture from an image captured by the camera unit or a signal sensed by the sensor unit, or by combining the captured image and the sensed signal.

The power supply 190 supplies power to the image display device 100.

Particularly, the power supply 190 may supply power to the controller 170 which may be implemented as a System On Chip (SOC), the display 180 for displaying an image, and the audio output unit 185 for audio output.

For supplying power, the power supply 190 may include a converter (not shown) for converting Alternating Current (AC) into Direct Current (DC). If the display 180 is configured with, for example, a liquid crystal panel having a plurality of backlight lamps, the power supply 190 may further include an inverter (not shown) capable of performing Pulse Width Modulation (PWM) for luminance change or dimming driving.

The remote controller 200 transmits a user input to the user input interface 150. For transmission of user input, the remote controller 200 may use various communication techniques such as Bluetooth, RF communication, IR communication, Ultra Wideband (UWB) and ZigBee.

In addition, the remote controller 200 may receive a video signal, an audio signal or a data signal from the user input interface 150 and output the received signals visually, audibly or as vibrations.

The above-described image display device 100 may be a fixed digital broadcast receiver capable of receiving at least one of ATSC (8-VSB) broadcast programs, DVB-T (COFDM) broadcast programs, and ISDB-T (BST-OFDM) broadcast programs.

The block diagram of the image display device 100 illustrated in FIG. 1 is purely exemplary. Depending upon the specifications of the image display device 100 in actual implementation, the components of the image display device 100 may be combined or omitted or new components may be added. That is, two or more components may be incorporated into one component or one component may be configured as separate components, as needed. In addition, the function of each block is described for the purpose of describing the aspect of this disclosure and thus specific operations or devices should not be construed as limiting the scope and spirit of this disclosure.

Unlike the configuration illustrated in FIG. 1, the image display device 100 may be configured so as to receive and play back video content through the network interface 130 or the external device interface 135, without the tuner 110 and the demodulator 120 shown in FIG. 1.

In some implementations, the image display device 100 may further include an ambient light sensor an illumination sensor (not shown) to sense an ambient light brightness.

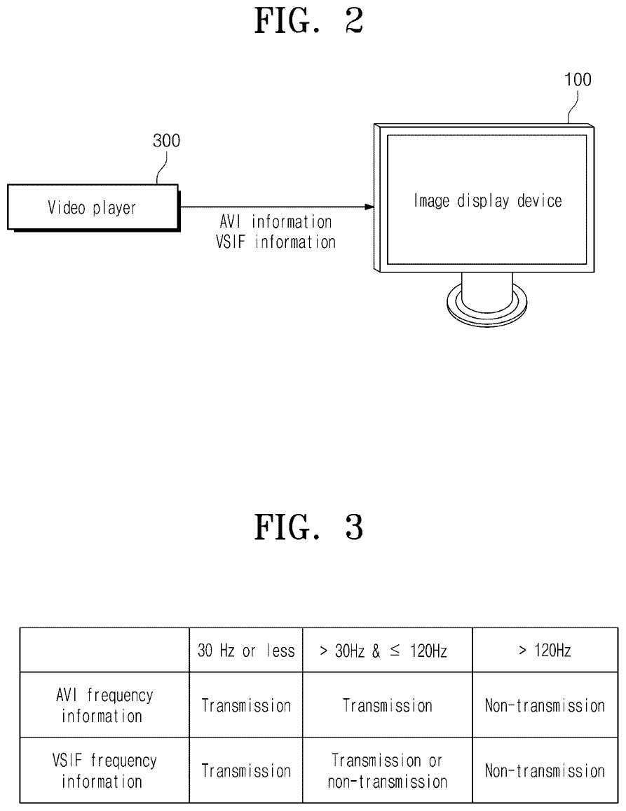

A method for enabling the image display device 100 to be connected to a video player 300 that plays back video signals will hereinafter be described with reference to FIG. 2. FIG. 2 is a diagram illustrating an example in which the image display device 100 is connected to a video player 300 according to one aspect of the present disclosure.

As illustrated in FIG. 2, the image display device 100 can be connected to the video player 300 by wire or wirelessly. The video player 300 is a device that generates, reproduces, or transmits a video signal, and may be, for example, a laptop, a personal computer, a smartphone, a tablet, a set-top box, etc. The video player 300 may output the video signal to the image display device 100. There is no limitation on the video signal that can be transmitted from the video player 300 to the image display device 100. For example, the video signal may be a moving image, a still image, or a streaming image.

The image display device 100 can be connected to the video player 300 via a wired or wireless connection through a network interface 130 or an external device interface 135. The network interface 130 and the external device interface 135 may also be referred to as a communication unit for communication with the video player 300.

Hereinafter, it will be assumed that the image display device 100 is connected to the video player 300 via HDMI, but the scope of the present disclosure is not limited thereto. The image display device 100 and the video player 300 may be connected to each other via DP, or may be connected in a Wi-Fi manner or a Bluetooth manner.

When the video player 300 outputs video signals to the image display device 100, the video player 300 may transmit at least one of AVI information and VSIF information regarding the video signals to the image display device 100.

The AVI information may include information regarding at least one of the frequency (or frame rate), resolution, RGB, and YCbCr of the video signal. The AVI information may be transmitted as an AVI-VIC number.

The VSIF information may include information regarding at least one of the frequency (or frame rate), resolution, and 3D image structure of the video signal. The VSIF information may be transmitted as a VSIF-VIC number.

Hereinafter, referring to FIG. 3, when a video signal is provided from the video player 300 to the image display device 100, a method for transmitting frequency information among the AVI information and VSIF information of the video signal from the video player 300 to the image display device 100 will be described based on the HDMI specification. FIG. 3 is a table regarding transmission of AVI information and VSIF information of a video signal according to one aspect of the present disclosure.

When the frequency of the video signal is 30 Hz or less, both the frequency information in the AVI information (hereinafter, AVI frequency information) and the frequency information in the VSIF information (hereinafter, VSIF frequency information) can be transmitted from the video player 300 to the image display device 100.

When the frequency of the video signal is more than 30 Hz and less than 120 Hz, the AVI frequency information can be transmitted from the video player 300 to the image display device 100. VSIF frequency information may or may not be transmitted from the video player 300 to the image display device 100. For example, whether or not the VSIF frequency is transmitted may be determined depending on the type of the video player 300.

When the frequency of the video signal exceeds 120 Hz, the AVI frequency information and the VSIF frequency information are not transmitted from the video player 300 to the image display device 100.

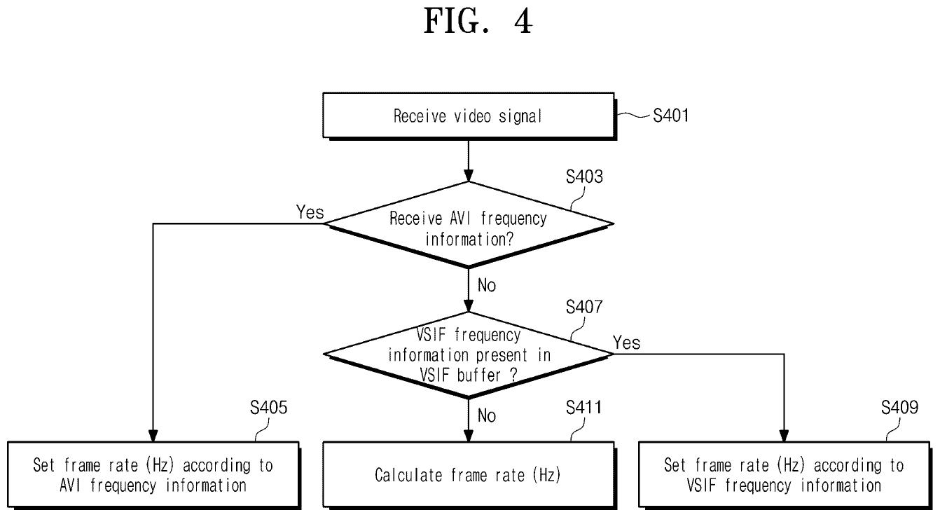

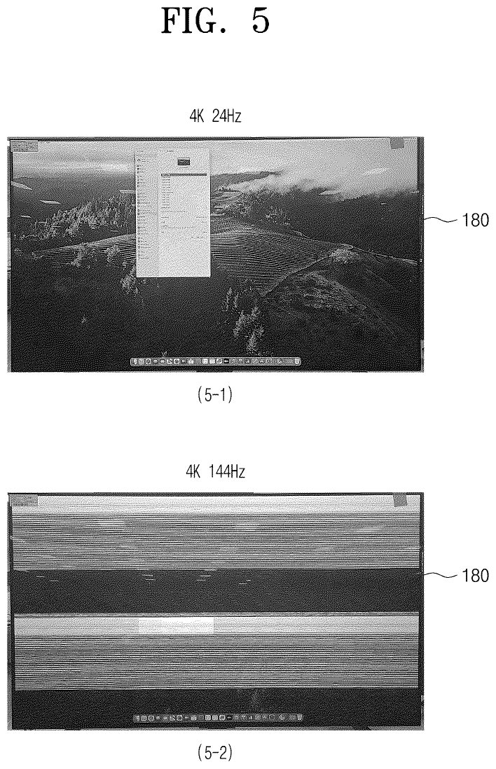

As described with reference to FIG. 3, a method for displaying video signals by the image display device 100 that receives not only the video signal but also the AVI frequency information and VSIF frequency information regarding the video signal will be described with further reference to FIGS. 4 and 5. FIG. 4 is a flowchart illustrating a method for enabling the image display device to display video signals according to one aspect of the present disclosure. FIG. 5 is a diagram illustrating an example of a screen image displayed by the image display device designed to use the method of FIG. 4 according to the present disclosure.

First, an example case in which the image display device 100 receives a first video signal having a frame rate of 120 Hz or less from the video player 300 will hereinafter be described with reference to the attached drawings.

The image display device 100 can receive the first video signal from the video player 300 (S401). The first video signal may be an HDMI-type video signal, but may also be another type of video signal.

The controller 170 may determine whether the first AVI frequency information of the first video signal has been received (or detected) (S403).

If the first AVI frequency information of the first video signal is received (or detected), the controller 170 may determine a frame rate for the first video signal based on the first AVI frequency information, and may display the video signal on the display 180 according to the determined frame rate (S405).

Meanwhile, the controller 170 may store the first VSIF information received together with the first video signal in the VSIF buffer while receiving the first video signal.

Therefore, if the first AVI frequency information of the first video signal is not received (or detected), the controller 170 may refer to a VSIF buffer (not shown) of the storage unit 140 (S407). For example, the first AVI frequency information of the first video signal may not be received or detected due to a transmission error of the first video signal.

If there is first VSIF frequency information in the VSIF buffer, the controller 170 may determine a frame rate for the first video signal based on the first VSIF frequency information and may display the first video signal on the display 180 according to the determined frame rate (S409).

If there is no first VSIF frequency information in the VSIF buffer, the controller 170 may calculate a frame rate from the first video signal and may display the first video signal on the display 180 according to the calculated frame rate (S411).

Regarding the method of calculating the frame rate from the video signal, there is a relationship between the frame rate and the pixel clock as shown below.

Horizontal size(or horizontal resolution)×Vertical size(or vertical resolution)×Frame rate=Pixel clock(Pixel CLK) [Equation 1]

The horizontal size, vertical size, and pixel clock of the video signal can be confirmed from the HDMI video signal. Therefore, the controller 170 may calculate the frame rate from the video signal using Equation 1.

Accordingly, as shown in (5-1) of FIG. 5, a first video signal having a frame rate of 120 Hz or less can be normally displayed on the display 180 according to the determined or calculated frame rate.

Since the frame rate is determined using the first AVI frequency information or the first VSIF frequency information, the video signal can be displayed quickly, and the number of cases in which the display of the video signal is delayed can be minimized by calculating the frame rate only when the first AVI frequency information and the first VSIF frequency information cannot be used.

Hereinafter, an example case in which a first video signal having a frame rate of 120 Hz or less after being received from the video player 300 by the image display device 100 is converted into a second video signal having a frame rate of more than 120 Hz will be described.

The image display device 100 may receive a second video signal from the video player 300 (S401). The second video signal may be an HDMI-type video signal, but may also be a video signal of another type.

The controller 170 may determine whether the second AVI frequency information of the second video signal has been received (or detected) (S403).

However, as described in FIG. 2, the second AVI frequency information is not transmitted for the second video signal having a frame rate of more than 120 Hz. Therefore, the controller 170 is unable to receive (or detect) the second AVI frequency information of the second video signal, and thus is unable to determine the frame rate for displaying the second video signal using the second AVI frequency information.

In addition, as described in FIG. 2, the second VSIF information is not transmitted for the second video signal having a frame rate of more than 120 Hz. Therefore, even if the controller 170 receives the second video signal, the controller 170 cannot store the second VSIF information in the VSIF buffer. As a result, the first VSIF information continues to remain in the VSIF buffer.

The reason why VSIF information remains in the VSIF buffer without being erased is that the interval at which VSIF information is transmitted from the video player 300 may not be constant, making it difficult to determine the time to crase VSIF information from the VSIF buffer. In addition, if VSIF information is transmitted after completion of such erasing, the image display device 100 may determine such transmission to be a change in the video signal, thereby causing unnecessary flickering.

However, as described above, since the first AVI frequency information of the first video signal is not received, the controller 170 should refer to the VSIF buffer of the storage unit 140 (S407).

However, since the first VSIF frequency information instead of the second VSIF frequency information is present in the VSIF buffer, the controller 170 may incorrectly set a frame rate for the second video signal based on the first VSIF frequency information, and may display the second video signal on the display 180 according to the incorrectly set frame rate (S409).

Therefore, as shown in (5-2) of FIG. 5, the second video signal having a frame rate exceeding 120 Hz may be abnormally displayed on the display 180 according to the incorrectly set frame rate.

Hereinafter, a method for normally displaying a second video signal even when a first video signal received from the video player 300 at a frame rate of 120 Hz or less is converted into a second video signal having a frame rate of more than 120 Hz will be described with reference to the attached drawings.

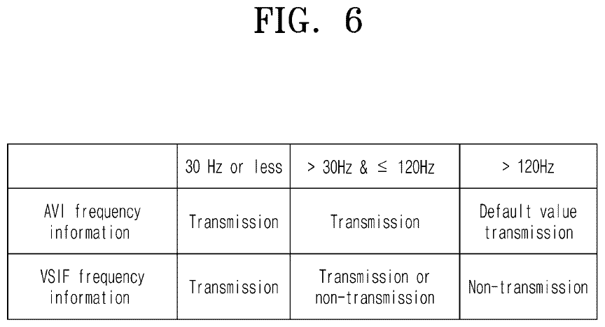

First, referring to FIG. 6, when a video signal is provided from the video player 300 to the image display device 100, a method for transmitting the frequency information among the AVI information and VSIF information of the video signal from the video player 300 to the image display device 100 based on the HDMI specification will be described. FIG. 6 is a table regarding transmission of AVI information and VSIF information of video signals according to one aspect of the present disclosure.

When the frequency of the video signal is 30 Hz or less, both the AVI frequency information and the VSIF frequency information can be transmitted from the video player 300 to the image display device 100.

When the frequency of the video signal is more than 30 Hz and less than 120 Hz, the AVI frequency information can be transmitted from the video player 300 to the image display device 100. The VSIF frequency information may or may not be transmitted from the video player 300 to the image display device 100.

If the frequency of the video signal exceeds 120 Hz, the original AVI frequency information of the video signal is not transmitted from the video player 300 to the image display device 100. However, instead of the original AVI frequency information of the video signal, a preset default value (for example, zero ‘0’) may be transmitted from the video player 300 to the image display device 100. The image display device 100 may recognize that the preset default value is the AVI frequency information of the video signal. The VSIF frequency information is still not transmitted from the video player 300 to the image display device 100.

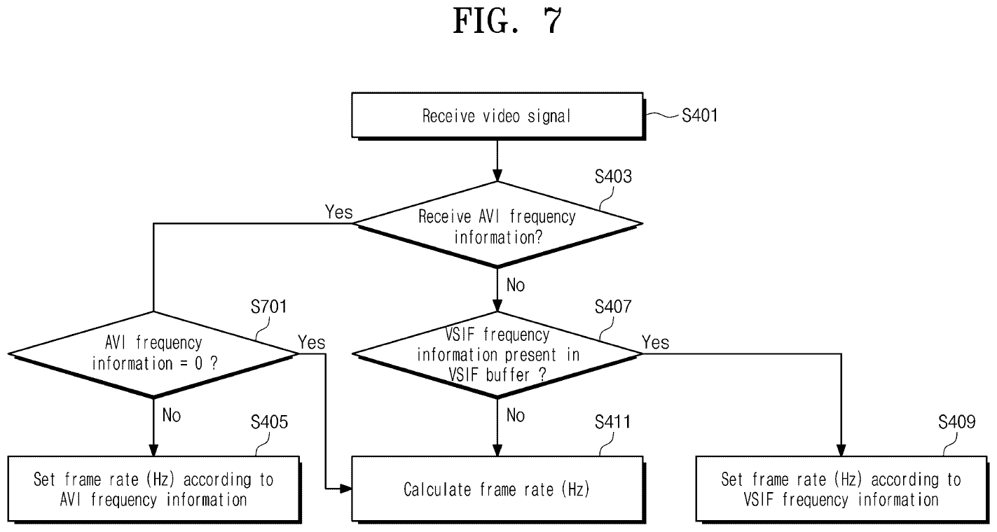

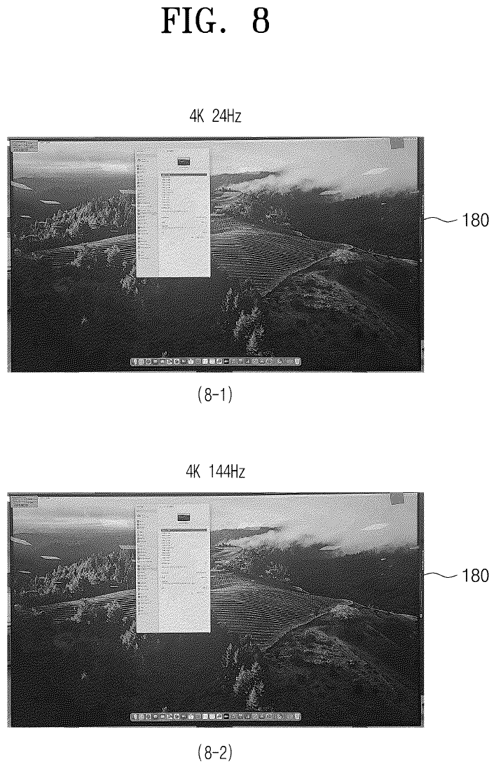

As described in FIG. 6, a method for displaying the video signal by the image display device 100 that receives not only the video signal but also the AVI frequency information and the VSIF frequency information thereof and displays the video signal will be described with further reference to FIGS. 7 and 8. FIG. 7 is a flowchart illustrating a method for enabling the image display device to display video signals according to one aspect of the present disclosure. FIG. 8 is a diagram illustrating an example of a screen image displayed by the image display device designed to use the method of FIG. 7 according to the present disclosure.

First, an example case in which the image display device 100 receives a first video signal having a frame rate of 120 Hz or less from the video player 300 will hereinafter be described with reference to the attached drawings.

The image display device 100 may receive a first video signal from the video player 300 (S401).

The controller 170 may determine whether the first AVI frequency information of the first video signal has been received (or detected) (S403).

If the first AVI frequency information of the first video signal has been received (or detected), the controller 170 can determine whether the first AVI frequency information is the preset default value (S701).

As described above, the first video signal having a frame rate of 120 Hz or less is transmitted with the original first AVI frequency information of the first video signal. In other words, the first AVI frequency information cannot be the preset default value.

Therefore, since the first AVI frequency information is not the preset default value, the controller 170 may set a frame rate for the first video signal based on the original first AVI frequency information of the first video signal, and may display the video signal on the display 180 according to the set frame rate (S405).

Meanwhile, the controller 170 can store the first VSIF information received together with the first video signal in the VSIF buffer while receiving the first video signal.

Therefore, if the first AVI frequency information of the first video signal is not received (or not detected), the controller 170 may refer to the VSIF buffer (not shown) of the storage unit 140 (S407).

If there is first VSIF frequency information in the VSIF buffer, the controller 170 may set a frame rate for the first video signal based on the first VSIF frequency information and may display the first video signal on the display 180 according to the set frame rate (S409).

If there is no first VSIF frequency information in the VSIF buffer, the controller 170 may calculate the frame rate from the first video signal and may display the first video signal on the display 180 according to the calculated frame rate (S411).

Since the method of calculating the frame rate from the video signal has already been described above, a detailed description thereof will herein be omitted for the sake of brevity of the present disclosure.

Therefore, as shown in (8-1) of FIG. 8, the first video signal having a frame rate of 120 Hz or less can be normally displayed on the display 180 according to the set or calculated frame rate.

Hereinafter, an example in which a first video signal having a frame rate of 120 Hz or less, which is received from the video player 300 by the image display device 100, is converted into a second video signal having a frame rate of more than 120 Hz will be described with reference to the attached drawings.

The image display device 100 may receive a second video signal from the video player 300 (S401).

The controller 170 may determine whether the second AVI frequency information of the second video signal has been received (or detected) (S403).

If the second AVI frequency information of the second video signal has been received (or detected), the controller 170 may determine whether the second AVI frequency information is the preset default value (S701).

As described above, the second video signal having a frame rate of more than 120 Hz transmits the preset default value instead of the original second AVI frequency information of the second video signal. That is, the second AVI frequency information is the same as the preset default value.

Accordingly, since the second AVI frequency information is the preset default value, the controller 170 may calculate the frame rate from the second video signal and may display the second video signal on the display 180 according to the calculated frame rate (S411).

That is, in the case of the second video signal having a frame rate of more than 120 Hz, instead of non-transmission of the original AVI frequency information, the preset default value instead of the original second AVI frequency information is transmitted and the controller 170 can avoid setting an incorrect frame rate for the second video signal based on the first VSIF frequency information present in the VSIF buffer by referring to the preset default value.

Therefore, as shown in (8-2) of FIG. 8, the second video signal having a frame rate exceeding 120 Hz can also be displayed normally on the display 180 according to the calculated frame rate.

Various aspects may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 170 of the image display device and a controller of the remote controller 200. The foregoing aspects are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary aspects described herein may be combined in various ways to obtain additional and/or alternative exemplary aspects.

What is claimed is:

1. An image display device comprising:
a display;
a communication unit configured to communicate with a video player; and
a controller configured to:
receive auxiliary video information (AVI) frequency information of a video signal received from the video player,
preset a frame rate of the video signal based on the received AVI frequency information when the AVI frequency information is not a preset default value, and
control the video signal to be displayed on the display according to the preset frame rate.

2. The image display device according to claim 1, wherein the controller is configured to:
calculate a frame rate based on the video signal when the AVI frequency information is a preset default value; and
control the video signal to be displayed on the display according to the preset frame rate.

3. The image display device according to claim 2, wherein the controller is configured to:
calculate the frame rate based on a horizontal resolution, a vertical resolution, and a pixel clock of the video signal.

4. The image display device according to claim 1, further comprising:
a storage unit,
wherein the controller is configured to:
when the AVI frequency information of the video signal is not received, preset the frame rate of the video signal based on vendor specific infoframe (VSIF) frequency information stored in a VSIF buffer present in the storage unit; and
control the video signal to be displayed on the display according to the preset frame rate.

5. The image display device according to claim 4, wherein the controller is configured to:
when the VSIF frequency information is not present in the VSIF buffer, calculate the frame rate based on the video signal; and
control the video signal to be displayed on the display according to the preset frame rate.

6. The image display device according to claim 1, wherein the controller is configured to:
when the frame rate of the video signal is less than or equal to a first frequency, receive original AVI frequency information of the video signal from the video player as the AVI frequency information; and
when the frame rate of the video signal is less than the first frequency, receive the preset default value from the video player as the AVI frequency information.

7. The image display device according to claim 6, wherein:
the first frequency is set to 120 Hz.

8. The image display device according to claim 4, wherein the controller is configured to:
when the frame rate of the video signal is less than or equal to a second frequency, receive the VSIF frequency information of the video signal from the video player, and store the received VSIF frequency information in the VSIF buffer.

9. The image display device according to claim 8, wherein:
the second frequency is set to 30 Hz.

10. The image display device according to claim 1, wherein:
the video signal is a high definition multimedia interface (HDMI)-type video signal.

11. A method for controlling an image display device comprising:
communicating with a video player;
receiving auxiliary video information (AVI) frequency information of a video signal received from the video player;
receiving auxiliary video information (AVI) frequency information of a video signal received from the video player;
presetting a frame rate of the video signal based on the received AVI frequency information when the AVI frequency information is not a preset default value; and
controlling the video signal to be displayed on a display according to the preset frame rate.

12. The method according to claim 11, further comprising:
calculating a frame rate based on the video signal when the AVI frequency information is a preset default value; and
controlling the video signal to be displayed on the display according to the preset frame rate.

13. The method according to claim 12, further comprising:
calculating the frame rate based on a horizontal resolution, a vertical resolution, and a pixel clock of the video signal.

14. The method according to claim 11, further comprising:
when the AVI frequency information of the video signal is not received, presetting the frame rate of the video signal based on vendor specific infoframe (VSIF) frequency information stored in a VSIF buffer present in a storage unit; and
controlling the video signal to be displayed on the display according to the preset frame rate.

15. The method according to claim 14, further comprising:
when the VSIF frequency information is not present in the VSIF buffer, calculating the frame rate based on the video signal; and
controlling the video signal to be displayed on the display according to the preset frame rate.

16. The method according to claim 11, further comprising:
when the frame rate of the video signal is less than or equal to a first frequency, receiving original AVI frequency information of the video signal from the video player as the AVI frequency information; and
when the frame rate of the video signal is less than the first frequency, receiving the preset default value from the video player as the AVI frequency information.

17. The method according to claim 16, wherein:
the first frequency is set to 120 Hz.

18. The method according to claim 14, further comprising:
when the frame rate of the video signal is less than or equal to a second frequency, receiving the VSIF frequency information of the video signal from the video player, and storing the received VSIF frequency information in the VSIF buffer.

19. The method according to claim 18, wherein:
the second frequency is set to 30 Hz.

20. The method according to claim 11, wherein:
the video signal is a high definition multimedia interface (HDMI)-type video signal.
